(19) United States
(12) Patent Application Publication
(10) Pub. No.: US 2014/0364092 A1
(43) Pub. Date: Dec. 11, 2014

(54) Method and Apparatus for Sharing Digital Content Employing Audible or Inaudible Signals

(71) Applicant: Robert Brett Rose, Boulder, CO (US)

(72) Inventor: Robert Brett Rose, Boulder, CO (US)

(73) Assignee: GOOGLE INC., Mountain View, CA (US)

(21) Appl. No.: 13/533,721

(22) Filed: Jun. 26, 2012

(51) Int. Cl. H04W 4/00

(52) U.S. Cl. 455/414.1

(57) ABSTRACT

A method and apparatus is provided for sharing digital content employing sounds. As an example, a first user selects or creates a piece of digital content using a client device. The content is uploaded to a server and is assigned a URL (Uniform Resource Locator). The URL is communicated from the server to the first user's client device. The URL is encoded into an audio signal by the first user's device. The audio signal is then transmitted to one or more other users as a sound. For example, the first user may be participating in a telephone call with one or more other users. The audio signal can be inserted into the audio stream of the telephone call. The one or more other users are using client devices that can detect the audio signal and can decode the audio signal back into the URL. The other users' client devices can then access the content via the URL.

### BACKGROUND

When one person establishes a telephone call connection with another person, it is oftentimes useful to share image files, video files, audio files, or other files with the other person to enhance and improve the communication. However, such telephone communication connections are not readily adapted to data transmission involving large amounts of digital content. Sending images and other media, either previously captured or captured in-the-moment, if feasible at all, is a tedious process that often involves using instant messaging or email to send the media. In such instances, data addresses for the intended recipient(s) are required thereby inhibiting anonymous connections and delivery of digital content.

For instance, in a telephone connection setting, a user may take a picture with his or her mobile phone while participating in the telephone conference call. Assuming that addresses are known for the participants (which often is not the case), it may be possible to send the picture to the others users on the conference by: (1) emailing the picture to the other users, (2) sending the picture to the other users via text message, or (3) sending the picture to the other users via a social networking service. However, these processes are often quite difficult and tedious for the sender. What is more, the sender is required to know the contact information for the other users (e.g., email address, cell phone number, and/or social networking username) in order to send the digital content to the other users. When the contact information is not otherwise known or readily available to the sender (e.g., stored in a contacts directory of the sender's mobile phone), the process for sending the communication becomes even more tedious since the sender must first obtain the contact information of the recipients. If one or more of the other users desires anonymity, then the process may become insurmountable.

Thus, such conventional systems are subject to failure making them unreliable and undesirable. Accordingly, there remains a need in the art for a method and apparatus for sharing digital content in an integrated manner that is reliably useful no matter the communication limitations and no matter if the participants maintain anonymity.

### BRIEF SUMMARY

One embodiment provides a digital content sharing system capable of sharing digital content where a first mobile phone and a second mobile phone are connected through a telephone call communication. Such digital content sharing system comprises: one or more servers; a first user mobile phone; and a second user mobile phone, wherein the first user mobile phone has a telephone call communication established with the second user mobile phone, the first user mobile phone also being capable of having a first data connection with the one or more servers wherein digital content on the first user mobile phone is transmitted to the one or more servers and the first user mobile phone identifies a URL (uniform resource locator) where the digital content may be accessed, the first user mobile phone encoding the URL into an encoded URL audio signal for audio transmission over the telephone call communication, and wherein the second user mobile phone is capable of receiving the encoded URL audio signal over the telephone call communication, the second user mobile phone decoding the encoded URL audio signal into the URL and accessing the digital content through a digital connection established with the one or more servers.

Other embodiments provide a client device capable of sharing a digital data file to another client device via a telephone call communication connection. Such client device comprises: at least one processor; an input/output module including a user interface configured to permit selection of a digital data file; a memory storing instructions executable by the at least one processor to cause initiation of transmission of such digital data file to a server location identifiable by a URL (uniform resource locator), identify the URL corresponding to the server location where the digital data file resides, and encode the URL into an audio signal; and, a communications module configured to establish a telephone call communication connection with one or more other client devices, such communication module also being configured to transmit the audio signal identifying the URL to the one or more other client devices employing the telephone call communication connection.

Another embodiment provides one or more computer-readable storage media storing instructions that when executed by at least one processor, cause a digital data item to be transmitted from a first user client device and accessed by a second user client device, by performing the steps of: receiving a selection of a digital data item to be transmitted from a first user client device and accessed by a second user client device; uploading the digital data item to a remote server; receiving a URL (uniform resource locator) corresponding to a location of the data item uploaded to the remote server; encoding the URL into an audio signal; and transmitting the audio signal to the second user client device while the first user client device and the second user client device are maintaining an audio telephone call communication session, said transmission being over the telephone call communication session.

### BRIEF DESCRIPTION OF THE DRAWINGS

FIG. 1 is a block diagram of an example communication environment, according to one embodiment.

FIG. 2 is a block diagram of example functional components for one of the client devices in FIG. 1, according to one embodiment.

FIG. 3 is a conceptual diagram of the arrangement of applications on a client device configured to transmit, according to one embodiment.

FIG. 4 is a conceptual diagram of the arrangement of applications on a client device configured to receive content, according to one embodiment.

FIGS. 5A-5D are conceptual diagrams of screenshots of a mobile phone configured to transmit an audio signal associated with digital content, according one embodiment.

FIGS. 6A-6B are conceptual diagrams of screenshots of a mobile phone configured to receive an audio signal associated with digital content, according one embodiment.

FIG. 7 is a flowchart illustrating transmitting an audio signal associated with digital content, according to one embodiment.

FIG. 8 is a flowchart illustrating receiving an audio signal associated with digital content, according to one embodiment.

### DETAILED DESCRIPTION

In an example embodiment for communicating content between users, a first user selects or creates a piece of digital content using a client device, such as a mobile phone. The content can be in the form of an image file, a video file, a document file, or other file. The content is uploaded to a remote server and is assigned a URL (Uniform Resource Locator). In one embodiment, the URL is publicly accessible without a password. In other embodiments, the URL may be password protected. The URL is communicated from the server to the first user's client device. The URL is encoded into an audio signal by the first user's device. The audio signal is then transmitted to one or more other users. For example, the first user may be participating in an audio communication session, e.g., telephone conference call, with one or more other users. The audio signal can be inserted into the audio stream of the conference call. In embodiments where the URL is password protected, the first user may communicate the password to the other users. For example, the first user may communicate the password via voice during the same conference call or may communicate the password via any other medium (e.g., email) at a later time.

The one or more other users may be using client devices that can detect the audio signal and can decode the audio signal back into the URL. The other users' client devices can then access the content via the URL.

In an example use case, two users are speaking on the phone to one another. One user wants to “phone-a-picture” to the other user. A photo is captured by the first user during the call, the photo is uploaded to a remote server, and the uploaded photo is assigned a URL, which may include any addressing protocol useable by multiple parties. The URL is transmitted to the first user's phone and is encoded into an audio signal. The audio signal is transmitted to the other user over the phone during the phone conversation. For example, the audio signal may sound like a fax machine or dial-up modem. The other user's phone detects the audio signal and decodes the audio signal into the URL. The URL can be accessed from the others user's phone during the conversation to view or download the content.

In this manner, content can be communicated to one or more other users without any knowledge of the contact information for the other user(s). For example, the first user does not need to know the email address, instant messenger screen name, social media username, or other contact info for the other user(s). In some cases, the phone number of the other user(s) may not be known, such as when the users are dialed into a conference call, e.g., via a conference call-in number. The encoded URL may be transmitted to the other user(s), but the entire file (which may be large) need not transmitted between the users. This may save a significant amount of bandwidth as compared to transmitting the entire file. Also, one-to-many communication may be provided in addition to one-to-one communication.

In some embodiments, to enhance security, the content may require a password, may no longer be available after a certain amount of time, or may no longer be available after a certain number of accesses, or include other security. In embodiments where the URL is password protected, the first user may communicate the password to the other users. For example, the first user may communicate the password via voice during the same conference call or may communicate the password via any other medium (e.g., email) at a later time.

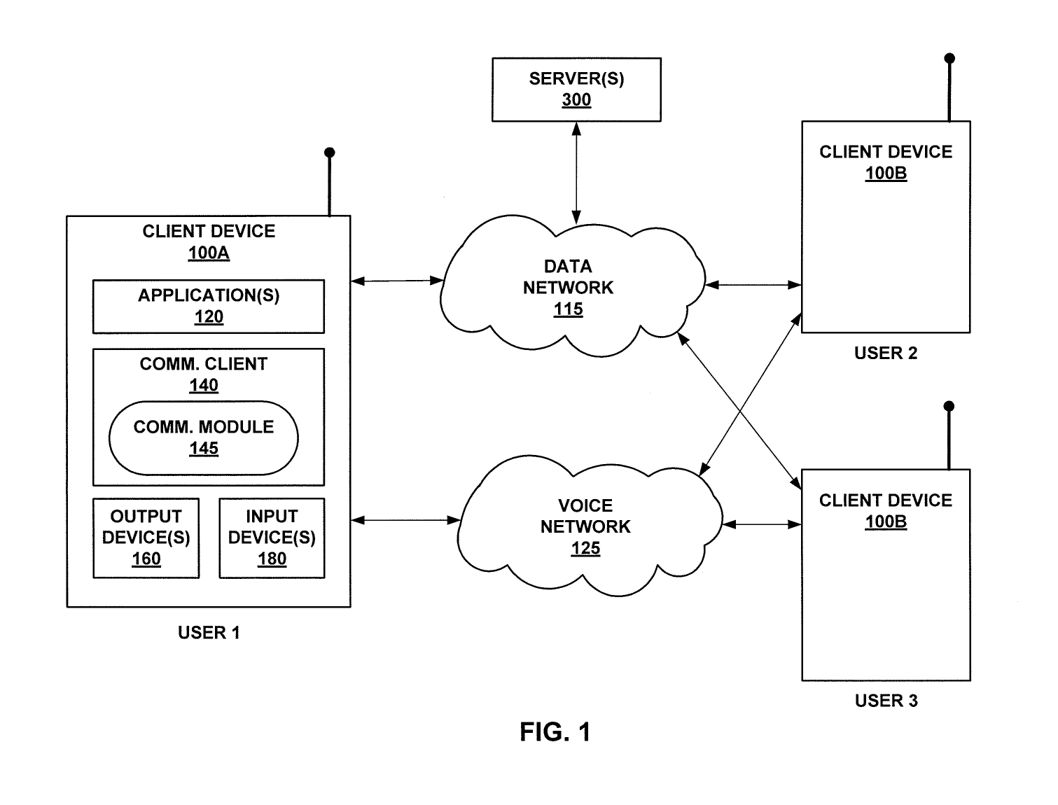

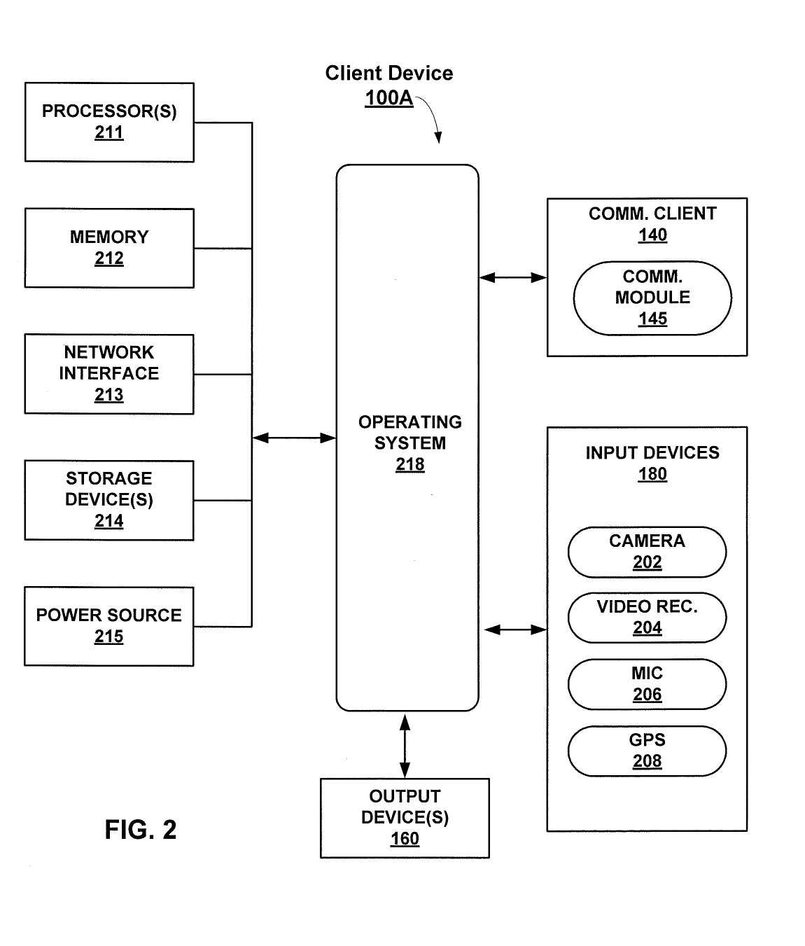

Another example communication environment is described in FIGS. 1-2. The illustrated communication environment is presented as an example, and does not imply any limitation regarding the use of other communication environments. In FIG. 1, the communication environment includes client devices 100A-100C, a data network 115, a voice network 125, and server(s) 300. Each of the client devices 100A-100C is in communication with the data network 115 and the voice network 125. Server(s) 300 are also in communication with the data network 115.

Examples of client devices 100A-100D include, but are not limited to, portable, mobile, and/or stationary devices such as landline telephones, mobile telephones (including mobile phones with advance computing capabilities, or “smartphones”), laptop computers, tablet computers, desktop computers, personal digital assistants (PDAs), portable gaming devices, portable media players, e-book readers, Internet-enabled televisions, or Internet-enabled appliances, among others. In some embodiments, two or more client devices 100A-100C comprise the same type of device. For example, client devices 100A and 100B may both be mobile phones. In other embodiments, two or more client devices are different types of devices. For example, client devices 100A and 100B may both be desktop computers and client device 100C may be a smartphone.

In the embodiment illustrated by FIG. 1, the client devices 100A-100C communicate with a server(s) 300 via data network 115. The data network 115 may comprise any type of network for communicating data, including a LAN (local area network), WAN (wide area network), cellular data network, VPN (virtual private network), enterprise network, or any other type of network that allows sharing of information and/or resources. The voice network 125 may be any type of network for voice communication, including a cellular phone network, a POTS (Plain Old Telephone Service) network, a conference call network, among others.

The server(s) 300 may comprise multiple physical servers. According to various embodiments, each server can equivalently be a physically separate machine or can be different processes running within the same physical machine.

The client device 100A of FIG. 1 includes application(s) 120, communications client 140, output devices 160 (e.g., a display), and input devices 180 (e.g., keyboard, mouse, touch screen, video recording device, audio recording device, GPS (global positioning module), photo capture device, etc.). In some embodiments, a device may act as both an output device and an input device. An example of application(s) 120 is a web browser application. Application(s) 120 provide the client device 100A with a variety of functionalities. Examples include social media functionality, web browsing capabilities, calendars, contact information, games, document processing, photo editing, document sharing, among others. Application(s) 120 employ the output devices 160 to display information at a graphical user interface (GUI).

The communications client 140 includes a communications module 145 that enables output devices 160 to display information at the GUI. The communications module 145 also enables the communications client 140 to connect to the server(s) 300. Typically, the communications module 145 is a network module that connects the client device 100A to the data network 115 (e.g., Internet) and/or voice network 125 (e.g., cellular phone network) using one of a variety of available network protocols. The GUI is configured to display data (such as, for example, audio and video data) received from the server(s) 300 via the data network 115 and/or received over the voice network 125.

In some embodiments, client devices 100B-100C include similar elements and functions as client device 100A. In other embodiments, client devices 100B-100D include different, fewer, or more elements and functions as client device 100A.

Some embodiments provide for a first user, using client device 100A, may capture new content, select content already stored on the client device 100A, or select content stored on server(s) 300. The content is uploaded to server(s) 300 via the data network 115, if not already stored on server(s) 300. The uploaded content is assigned a URL that is returned from the server(s) 300 to the client device 100A. In another embodiment, the client device is configured to detect the URL of the content stored on the server(s) 300.

One or more applications 120 executing on the client device are configured to encode the URL into an audio signal. The audio signal is then transmitted to one or more other users via the voice network 125. The client devices 100B, 100C of the one or more other users include one or more applications 120 configured to detect the audio signal and decode the audio signal into the URL corresponding to the content. The client devices 100B, 100C also include one or more applications 120 configured to access the content at the URL, e.g., a web browser application or any other application that can access an HTTP (Hypertext Transfer Protocol) address.

In one embodiment, the server to which the content is uploaded from client device 100A is the same physical server from which the client devices 100B, 100C access the content. In other embodiments, the server to which client device 100A uploads the content is different from the server from which client devices 100B or 100C access the content, though they may be considered one virtual server. As an example, the different physical servers can be operated by separate mobile phone service providers, though they may act as a single virtual server.

Referring now to FIG. 2, one particular example of client device 100A is illustrated. Many other embodiments of the client device 100A may be used. In the illustrated embodiment of FIG. 2, the client device 100A includes one or more processor(s) 211, memory 212, a network interface 213, one or more storage devices 214, a power source 215, output device(s) 160, and input device(s) 180. The client device 100A also includes an operating system 218 and a communications client 140 that are executable by the client. Each of components 211, 212, 213, 214, 215, 160, 180, 218, and 140 is interconnected physically, communicatively, and/or operatively for inter-component communications in any operative manner.

As illustrated, processor(s) 211 are configured to implement functionality and/or process instructions for execution within client device 100A. For example, processor(s) 211 execute instructions stored in memory 212 or instructions stored on storage devices 214. Memory 212, which may be a non-transient, computer-readable storage medium, is configured to store information within client device 100A during operation. In some embodiments, memory 212 includes a temporary memory, area for information not to be maintained when the client device 100A is turned OFF. Examples of such temporary memory include volatile memories such as random access memories (RAM), dynamic random access memories (DRAM), and static random access memories (SRAM). Memory 212 maintains program instructions for execution by the processor(s) 211.

Storage devices 214 also include one or more non-transient computer-readable storage media. Storage devices 214 are generally configured to store larger amounts of information than memory 212. Storage devices 214 may further be configured for long-term storage of information. In some examples, storage devices 214 include non-volatile storage elements. Non-limiting examples of non-volatile storage elements include magnetic hard disks, optical discs, floppy discs, flash memories, or forms of electrically programmable memories (EPROM) or electrically erasable and programmable (EEPROM) memories.

The client device 100A uses network interface 213 to communicate with external devices via one or more networks, such data network 115 and/or voice network 125. Network interface 213 may be a network interface card, such as an Ethernet card, an optical transceiver, a radio frequency transceiver, or any other type of device that can send and receive information. Other non-limiting examples of network interfaces include wireless network interface, Bluetooth®, 3G and WiFi® radios in mobile computing devices, and USB (Universal Serial Bus). In some embodiments, the client device 100A uses network interface 213 to wirelessly communicate with an external device such as the server(s) 300 of FIG. 1, a mobile phone, or other networked computing device.

The client device 100A includes one or more input devices 180. Input devices 180 are configured to receive input from a user through tactile, audio, video, or other sensing feedback. Non-limiting examples of input device 180 include a presence-sensitive screen, a mouse, a keyboard, a voice responsive system, camera 202, a video recorder 204, a microphone 206, a GPS module 208, or any other type of device for detecting a command from a user or sensing the environment. In some examples, a presence-sensitive screen includes a touch-sensitive screen.

One or more output devices 160 are also included in client device 100A. Output devices 160 are configured to provide output to a user using tactile, audio, and/or video stimuli. Output devices 160 may include a display screen (part of the presence-sensitive screen), a sound card, a video graphics adapter card, or any other type of device for converting a signal into an appropriate form understandable to humans or machines. Additional examples of output device 160 include a speaker, a cathode ray tube (CRT) monitor, a liquid crystal display (LCD), or any other type of device that can generate intelligible output to a user. In some embodiments, a device may act as both an input device and an output device.

The client device 100A includes one or more power sources 215 to provide power to the client device 100A. Non-limiting examples of power source 215 include single-use power sources, rechargeable power sources, and/or power sources developed from nickel-cadmium, lithium-ion, or other suitable material.

The client device 100A includes an operating system 218, such as the Android® operating system. The operating system 218 controls operations of the components of the client device 100A. For example, the operating system 218 facilitates the interaction of communications client 140 with processors 211, memory 212, network interface 213, storage device(s) 214, input device 180, output device 160, and power source 215.

As illustrated in FIG. 2, the client device 100A includes communications client 140. Communications client 140 includes communications module 145. Each of communications client 140 and communications module 145 includes program instructions and/or data that are executable by the client device 100A. For example, in one embodiment, communications module 145 includes instructions causing the communications client 140 executing on the client device 100A to perform one or more of the operations and actions described in the present disclosure. In some embodiments, communications client 140 and/or communications module 145 form a part of operating system 218 executing on the client device 100A.

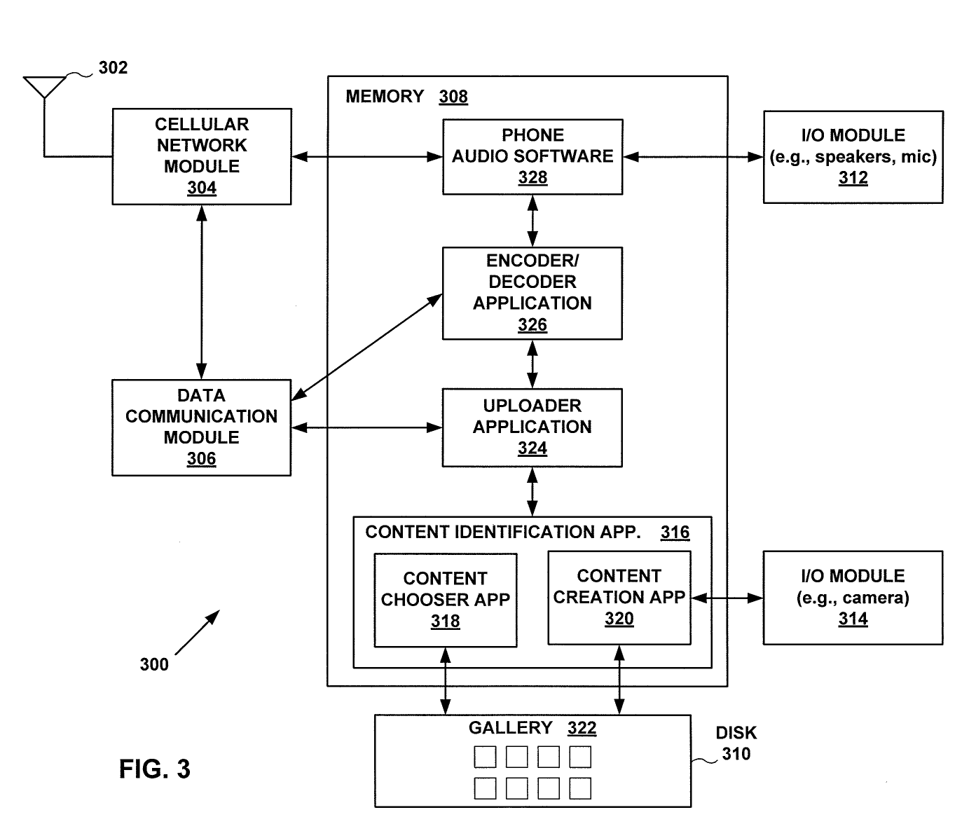

FIG. 3 is a conceptual diagram of the arrangement of applications on a client device configured to transmit an audio signal associated with digital content, according to one embodiment. As shown, a client device 300 includes an antenna 302, a cellular network module 304, a data communication module 306, a memory 308, a disk 310, and I/O (input/output) modules 312, 314. The memory 308 includes various applications that are executed by a processor (not shown), including a content identification application 316, an uploader application 324, an encoder/decoder application 326, and phone audio software 328. The content identification application 316 includes a content chooser application 318 and a content creation application 320. The disk 310 includes non-volatile storage where digital content can be stored on the client device 300, such as in a gallery 322.

To initiate the transmission the audio signal associated with the digital content, a user first selects the digital content to be transmitted. The content may have been previously captured and can be selected from a gallery 322 via the content chooser application 318. Alternatively, the content may be captured at the time that the user wishes to transmit the content via I/O module 314 and content creation application 320. After the content has been selected, the user provides an input into a user interface that causes the content to be uploaded to a server by the uploader application 324. The uploader application 324 uploads the content via the data communication module 306 and the cellular network module 304. In other embodiments that do not involve a mobile phone, the uploader application 324 may upload the content to the server via the appropriate hardware, e.g., network card.

After the content is uploaded to the server, the server returns a URL corresponding to the content to the uploader application 324 via the cellular network module 304 and the data communication module 306. The uploader application 324 communicates the URL to the encoder/decoder application 326.

The encoder/decoder application 326 is configured to encode the URL into an audio signal. In one embodiment, the frequency of the encoded audio signal is above or below the range of human hearing. In other embodiments, the encoded audio signal can be human recognizable, much like a fax machine or acoustic modem. Also, in some embodiments, a predefined start-of-message code may be prepended before the encoded audio signal and/or a predefined end-of-message code may be appended after the encoded audio signal. Any tone generation method can be used to encode the URL into an audio signal. One example includes dual-tone multi-frequency (DTMF) signaling used for signaling over analog telephone lines. For example, the URL can be encoded into tones that can be transmitted during the audio conversation.

In some embodiments, a URL shortening operation may be performed onto the URL in order to shorten the URL and reduce the length of the transmission. Examples of services that provide such functionality include “goo.gl” provided by Google® and “tinyURL.com.” In this manner, the length of the audio signal that is inserted into the audio conversation can be decreased.

The encoded audio signal with prepended and/or appended codes is then communicated from the encoder/decoder application 326 to the phone audio software 328 that inserts the audio signal and/or codes into the audio stream of a voice conservation. The phone audio software 328 may comprise firmware for facilitating a phone conversion between two users. The phone audio software 328 may also be associated with an API (application programming interface) that allows additional audio information to be inserted into the phone conversation. In one embodiment, the API is used to insert the encoded audio signal into the phone conversation between the two users. In other embodiments, any other technologically feasible process may be implemented to insert the audio of the encoded audio signal into the phone conversation. In some embodiments, the encoded signal and/or cores may be repeated one or more times so that the receiver device can properly receive the message.

As shown in the embodiment in FIG. 3, each of the content identification application 316, the uploader application 324, the encoder/decoder application 326, and the phone audio software 328 are shown as separate software applications. In other embodiments, the functionality of the content identification application 316, the uploader application 324, the encoder/decoder application 326, and the phone audio software 328 can be combined into a single software application (e.g., mobile phone “app”). In still further embodiments, the functionality of the content identification application 316, the uploader application 324, the encoder/decoder application 326, and the phone audio software 328 may be included in the operating system of the client device 300.

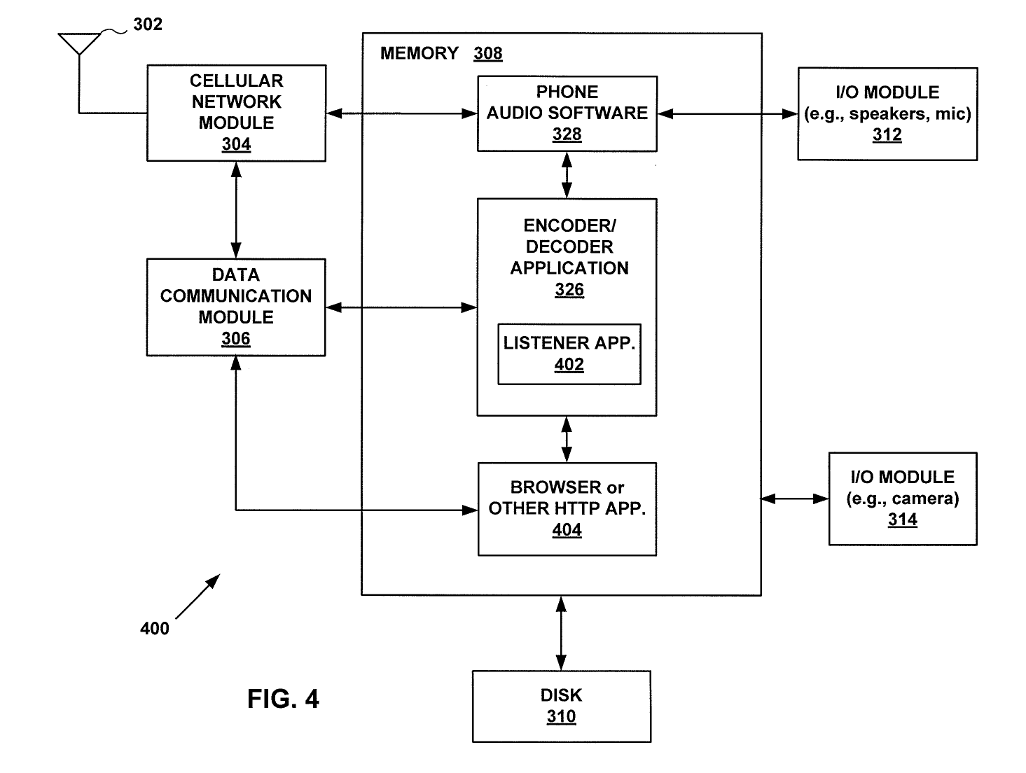

FIG. 4 is a conceptual diagram of the arrangement of applications on a client device configured to receive an audio signal associated with digital content, according to one embodiment. In one embodiment, and as shown, client device 400 includes the same components as client device 300 shown in FIG. 3. For example, client device also includes antenna 302, a cellular network module 304, a data communication module 306, a memory 308, a disk 310, and I/O (input/output) modules 312, 314. The memory 308 includes various applications that are executed by a processor (not shown), including an encoder/decoder application 326, phone audio software 328, and a browser or other HTTP-compliant application 404. In addition, the encoder/decoder application 326 includes a listener application 402. In other embodiments, the listener application 402 may be a separate software application from the encoder/decoder application 326.

The listener application 402 is configured to listen to the audio stream of the phone conversation via the phone audio software 328. In one embodiment, an API into the phone audio software 328 allows other applications, such as the listener application 402, to listen to the audio stream of the phone conversation. When the listener application 402 detects a start-of-message code in the audio stream, the listener application begins recording the encoded audio signal that follows the start-of-message code. The listener application stops recording when an end-of-message code is detected. The listener application 402 provides the received encoded audio signal to the encoder/decoder application 326, which is configured to decode the audio signal into a text-based URL. As described, the URL corresponds to some piece of digital content stored on a server.

In another embodiment, the start-of-message and end-of-message codes are not prepended and appended, respectfully, to the encoded audio signal. On the recipient user's side, the listener application can detect the audio signal itself and extract the audio signal from the audio stream of the phone conversation.

The encoder/decoder application 326 transmits the decoded URL to the browser application or other HTTP-compliant application 404. The application 404 is configured to access the URL and retrieve the content, either to view or download. In some embodiments, the application 404 is configured to perform an HTTP “GET” operation on the URL to retrieve certain metadata associated with the content located at the URL before retrieving the full content. For example, the application 404 may be configured to retrieve the filename, file size, and/or author of the content. The metadata can be displayed to the recipient user who can use this information to determine whether the full content should be accessed now, later, or at all. In addition, now that the recipient user has the URL, the recipient user can also perform many other operations with the URL, including sharing the URL with others via instant messenger, social networking websites, and/or email or saving the URL for later viewing. In an example use case, the recipient user can retrieve a photo received via the audio signal during the conversation, view the photo, and then post the photo to a social networking website.

In the embodiment shown in FIG. 4, and similar to the applications shown in FIG. 3, the encoder/decoder application 326, the phone audio software 328, the listener application 402, and the application 404 are shown as separate software applications. In other embodiments, the functionality of the encoder/decoder application 326, the phone audio software 328, the listener application 402, and the application 404 can be combined into a single software application (e.g., mobile phone “app”). In still further embodiments, the functionality of the encoder/decoder application 326, the phone audio software 328, the listener application 402, and the application 404 may be included in the operating system of the client device 400.

In addition, in the embodiments shown in FIGS. 3-4, the client devices 300 and 400 are shown to have different applications stored in the respective memories. In another embodiment, the applications stored on both devices are the same.

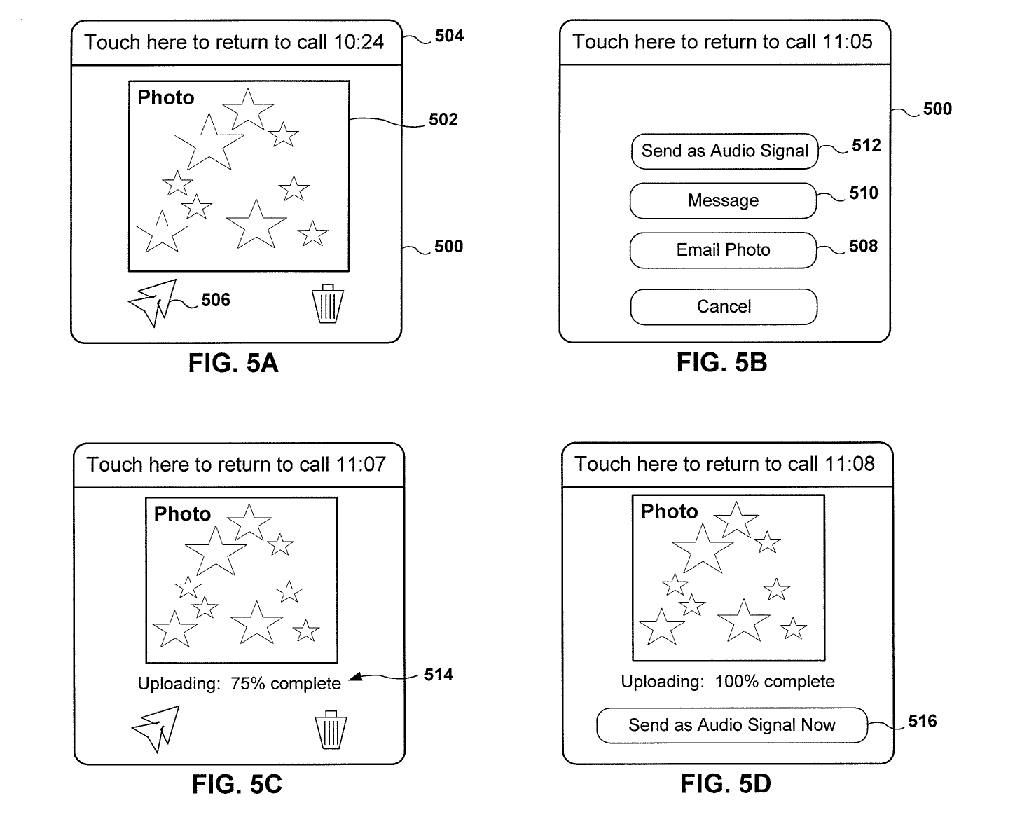

FIGS. 5A-5D are conceptual diagrams of screenshots of a mobile phone 500 configured to transmit an audio signal associated with digital content, according one embodiment. A transmitting user is operating mobile phone 500. As shown in FIG. 5A, the transmitting user may be participating in a phone conversation with a recipient user, as shown via status bar 504. The transmitting user can create new content or select a piece of content already stored on the mobile phone to transmit to the recipient user. In the example shown, the transmitting user has selected a photo 502. The transmitting user can select an icon 506 that provides transmission options.

As shown in FIG. 5B, after the icon 506 is selected by the transmitting user, an interface is displayed on the mobile phone 500 that provides transmission options for the photo 502. For example, the transmission options may include email 508, text message 510, or sending the photo as an audio signal 512.

As shown in FIG. 5C, after the user has selected to send the photo 502 as an audio signal 512, the photo 502 is uploaded 514 to a server. After the upload has completed, the mobile phone 500 receives a URL for the uploaded content. In another embodiment, the mobile phone 500 is configured to detect the URL of the uploaded content. As described above, one or more software applications on the mobile phone are configured to encode the URL into an audio signal.

As shown in FIG. 5D, once the audio signal is encoded, the transmitting user is provided with an interface button 516 to send the audio signal now, via the phone conversation. In some embodiments, the audio signal is not audible to the human ear. In other embodiments, the audio signal is audible and may sound similar to a fax or dial-up modem connecting.

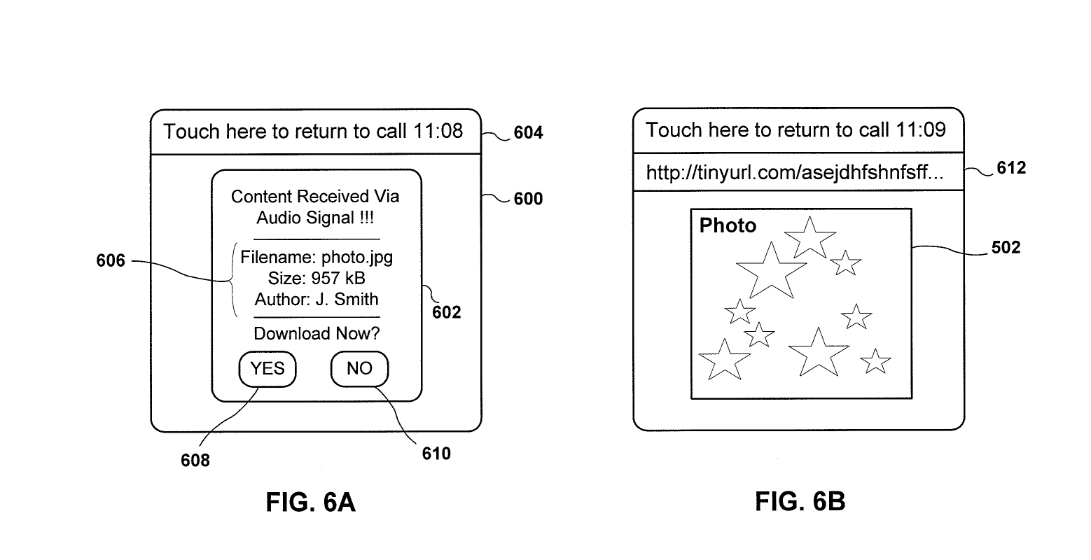

FIGS. 6A-6B are conceptual diagrams of screenshots of a mobile phone 600 configured to receive an audio signal associated with digital content, according one embodiment. A recipient user is operating mobile phone 600. As shown in FIG. 6A, the recipient user may be participating in a phone conversation with the transmitting user, as shown via status bar 604. As described above, the mobile phone 600 of the recipient user is configured with a listener application configured to listen to the audio conversation and detect certain audio signals. When an encoded audio signal is detected, an encoder/decoder application on the mobile phone 600 decodes the audio signal into a text-based URL.

An alert 602 may be presented to the recipient user indicating that an audio signal has been detected. As also described above, an HTTP GET operation may be performed by an application executing on the mobile phone 600 to retrieve certain metadata 606 associated with the URL. Example metadata 606 includes a filename, file size, and/or author of the content corresponding to the URL. The recipient user is provided with options 608, 610 to access the data at the URL. If the recipient user chooses to access the data via option 608, the content is accessed via a browser application or other HTTP-compliant application on the mobile phone 600. As shown in FIG. 6B, the photo 502 is displayed on the mobile phone 600. In some embodiments, the URL 612 of the content may also be displayed. Again, the transmitting user and the recipient user remain engaged in a phone conversation during the entire process illustrated in FIGS. 5A-5D and FIGS. 6A-6B.

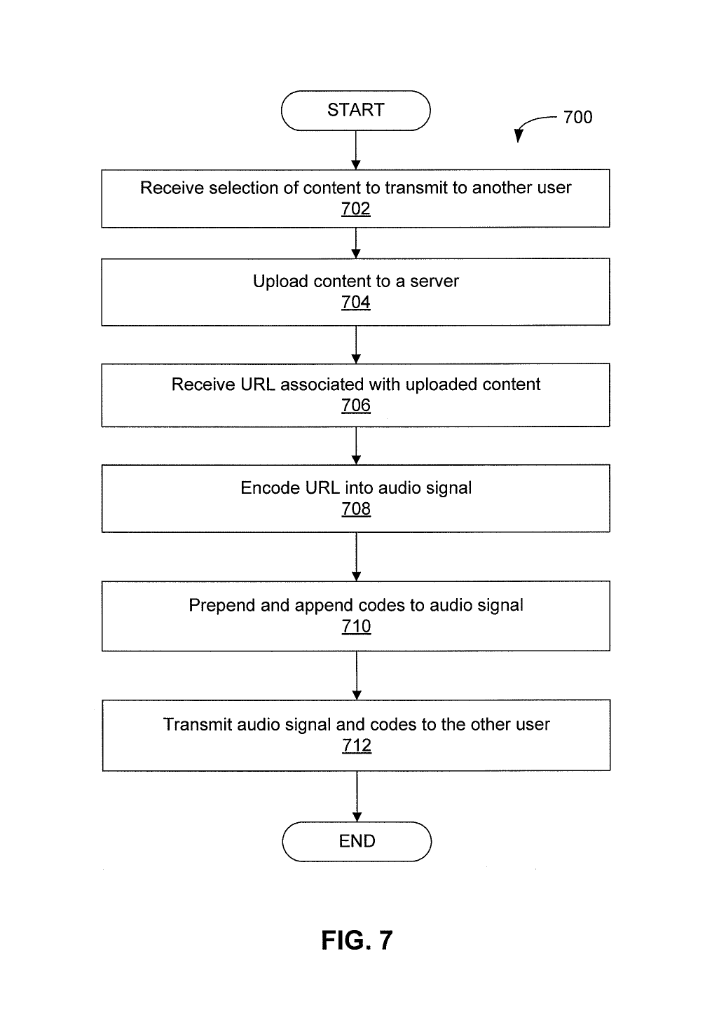

FIG. 7 is a flowchart illustrating transmitting an audio signal associated with digital content, according to one embodiment. Persons skilled in the art will understand that even though the method 700 is described in conjunction with the systems of FIGS. 1-6B, any system configured to perform the method stages is within the scope of embodiments of the disclosure.

As shown, at stage 702, a software application executing on a transmitting user's client device receives a selection of content to transmit to another user. Example content includes images, video, links to a webpage, notes, calendar entries, or any other type of electronic file. As described, the transmitting user is participating in a phone conversation with one or more other users. The content may have just been created by the transmitting user (i.e., during the phone conversation) or may have been previously created. The content may be selected from a list of content available on the transmitting user's client device or in a cloud storage system, such as Google® Drive™, Dropbox, or Apple® iCloud®.

At stage 704, the software application uploads the content to a server. In some embodiments, the content may have been previously uploaded to the server. For example, the transmitting user may have various files stored in a cloud storage system. The selection at stage 702 may be to select a file stored in such a cloud storage system.

At stage 706, the software application receives a URL associated with uploaded content from the server. The URL may be several dozen characters long. However, the URL does not need to be displayed to the transmitting user. In fact, the transmitting user may not even be aware of the URL for the content.

At stage 708, the software application identifies the URL into an audio signal. In one embodiment, the software application receives the URL from the server. In another embodiment, the software application detects the URL of the content after the content has been uploaded. The encoded signal may or may not be audible to the human ear. At stage 710, the software application prepends a start-of-message code to the beginning on the encoded audio signal and appends an end-of-message code to the end of the audio signal. In one embodiment, the prepended and appended codes surround the data of the audio signal.

At stage 712, the software application causes the audio signal and codes to be transmitted to the other users during the phone conversation. The encoded signal and codes may or may not be audible to the human ear. In some embodiments, the transmitting user's microphone may be muted during transmission of the encoded signal and codes so as to not insert noise into the encoded signal and codes.

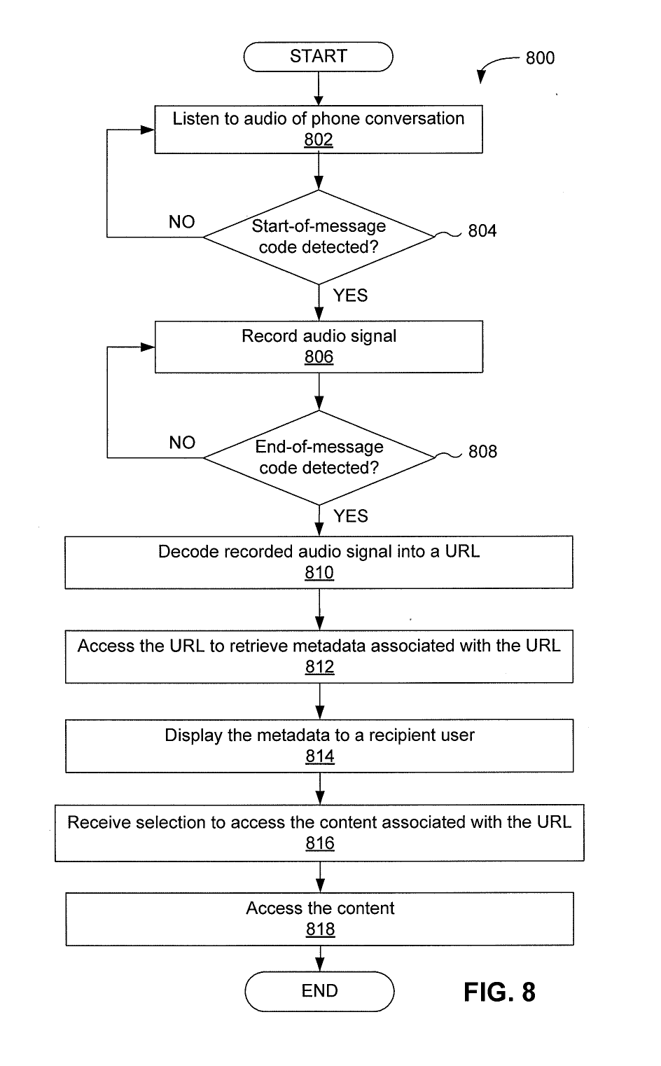

FIG. 8 is a flowchart illustrating receiving an audio signal associated with digital content, according to one embodiment. Persons skilled in the art will understand that even though the method 800 is described in conjunction with the systems of FIGS. 1-6B, any system configured to perform the method stages is within the scope of embodiments of the disclosure.

As shown, at stage 802, a software application executing on a recipient user's client device listens to the audio stream of a phone conversation between the recipient user, the transmitting user, and zero or more other users. At stage 804, the software application determines whether a start-of-message code has been detected in the audio stream of the phone conversation.

If the software application does not detect a start-of-message code, then the method 800 returns to stage 802. If the software application does detect a start-of-message code, then the method 800 proceeds to stage 806.

At stage 806, the software application starts recording the audio signal that follows the start-of-message code. At stage 808, the software application determines whether an end-of-message code has been detected in the audio stream of the phone conversation. If the software application does not detect an end-of-message code, then the method 800 returns to stage 806 and the audio signal continues to be recorded by the software application. If the software application does detect an end-of-message code, then the software application stops recording and the method 800 proceeds to stage 810.

At stage 810, the software application decodes the recorded audio signal into a URL. At stage 812, the software application accesses the URL to retrieve metadata associated with the URL. In one example, the metadata can be retrieved by performing an HTTP GET operation on the URL.

At stage 814, the software application causes the metadata to be displayed to a recipient user on the recipient user's client device. The metadata may provide the recipient user with enough information to make a decision as to whether the content associated with the URL should be accessed. Examples of such metadata include a filename, a file size, and/or an author of the content associated with the URL.

At stage 816, the software application receives a selection from the recipient user to access the content associated with the URL. At stage 818, the software application accesses the content. Accessing the content may comprise viewing a webpage associated with the URL and/or downloading the content associated with the URL to the recipient user's client device.

In this manner, content can be communicated to one or more other users without any knowledge of the contact information for the other user(s). For example, the first user does not need to know the email address, instant messenger screen name, social media username, or other contact info for the other user(s). In some cases, the phone number of the other user(s) may not be known, such as when the users are dialed into a conference call, e.g., via a conference call-in number. Also, the encoded URL is transmitted to the other user(s), but the entire file (which may be large) is not transmitted between the users. This may save a significant amount of bandwidth as compared to transmitting the entire file. Also, a one-to-many communication may be provided in addition to one-to-one communication. In some embodiments, to enhance security, the content may require a password, may no longer be available after a certain amount of time, or may no longer be available after a certain number of accesses.

In the example embodiments, the various applications can be configured on any distributed or embedded platform within a single physical location or multiple locations. As such, embodiments contemplate that applications, resources, managers, servers, etc. may be joined or separated without diverging from their identities and functions. For example, a “server device” may equivalently include a single server platform or multiple server platforms.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

Some embodiments of this disclosure are described herein, including the best mode known for carrying out the disclosure. Variations of those preferred embodiments may become apparent to those of ordinary skill in the art upon reading the foregoing description. Skilled artisans are expected to employ such variations as appropriate, and the disclosure is expected to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A digital content sharing system capable of sharing digital content, comprising:
a first mobile phone configured to establish a telephone call communication with one or more other mobile phones and to establish a first data connection with one or more servers; and
a second mobile phone that has a telephone call communication established with the first mobile phone, wherein digital content on the first mobile phone is transmitted to the one or more servers during the telephone call communication established between the first mobile phone and the second mobile phone, and wherein the one or more servers are configured to assign a URL (uniform resource locator) for the digital content;
wherein the first mobile phone identifies the URL at which the digital content may be accessed and encodes the URL into an encoded URL audio signal for audio transmission over the telephone call communication, and
wherein the second mobile phone is configured to:
receive the encoded URL audio signal over the telephone call communication,
decode the encoded URL audio signal into the URL,
retrieve metadata associated with the digital content corresponding to the URL from the one or more servers, wherein the metadata includes one or more of a filename of the digital content, a file size of the digital content, and an author of the digital content,
cause information about the metadata to be displayed on the second client device,
receive a selection to access the digital data item based on the second client device displaying the information about the metadata, and
accessing the digital content through a digital connection established with the one or more servers.

2. The system according to claim 1, wherein a password is required to access the digital content.

3. The system according to claim 1, wherein the digital content is capable of being accessed via the URL for a certain amount of time or for a certain number of accesses.

4. The system according to claim 1, wherein the first mobile phone is further capable of performing a URL shortening operation to obtain a shortened URL and encoding the shortened URL using dual-tone multi-frequency (DTMF) signaling.

5. A client device capable of sharing a digital data file to another client device during a telephone call communication connection, such client device comprising:
at least one processor;
an input/output module including a user interface configured to permit selection of a digital data file;
a memory storing instructions executable by the at least one processor to:
cause initiation of transmission of the digital data file to a server location during the telephone call communication connection established with one or more other client devices, the digital data file identifiable by a URL (uniform resource locator),
identify the URL corresponding to the server location where the digital data file is stored, and
encode the URL into an audio signal; and,
a communications module configured to establish a telephone call communication connection with the one or more other client devices, such communication module also being configured to transmit the audio signal identifying the URL to the one or more other client devices employing the telephone call communication connection, wherein the digital data file is associated with metadata that includes one or more of a filename of the digital data file, a file size of the digital data file, and an author of the digital data file, such that the one or more other client devices are configured to retrieve the metadata associated with the digital data file from the server location, display information about the metadata, receive a selection to access the digital data file based on displaying the information about the metadata, and access the digital data file through a connection established with the server location.

6. The client device according to claim 5, wherein encoding the URL into the audio signal comprises:
performing a URL shortening operation to obtain a shortened URL; and
encoding the shortened URL using dual-tone multi-frequency (DTMF) signaling.

7. The client device according to claim 5, further comprising:
a data module configured to upload the digital data file to the server location.

8. The client device according to claim 5, wherein a phone conversation occurs over the telephone call communication connection.

9. The client device according to claim 5, wherein the digital data file comprises an image file, a video file, or a document file.

10. The client device according to claim 5, wherein the communications module comprises a wireless communication module.

11. The client device according to claim 5, wherein the instructions further cause the apparatus to prepend a first code to the beginning of the audio signal and/or append a second code the end of the audio signal, and wherein the communications module is further configured to transmit the first code and/or the second code to the one or more other client devices.

12. The client device according to claim 5, wherein identifying the URL comprises receiving the URL from a server.

13. The client device according to claim 5, further comprising a capture device configured to capture digital content during the telephone call communication connection.

14. One or more non-transitory computer-readable storage media storing instructions that, when executed by at least one processor, cause a digital data item to be transmitted from a first client device and accessed by a second client device, by performing the steps of:
receiving a selection of a digital data item to be transmitted from a first client device and accessed by a second client device;
uploading the digital data item to a remote server during an audio telephone call communication session maintained between the first client device and the second client device;
receiving a URL (uniform resource locator) corresponding to a location of the digital data item uploaded to the remote server;
encoding the URL into an audio signal; and
transmitting the audio signal to the second client device while the first client device and the second client device are maintaining the audio telephone call communication session, said transmission being over the telephone call communication session, wherein the second client device is configured to retrieve metadata associated with the digital data item corresponding to the URL from the remote server, cause information about the metadata to be displayed on the second client device, and receive a selection to access the digital data item based on displaying the information about the metadata, wherein the metadata includes one or more of a filename of the digital data item, a file size of the digital data item, and an author of the digital data item.

15. The computer-readable storage media according to claim 14, wherein encoding the URL into the audio signal comprises:
performing a URL shortening operation to obtain a shortened URL; and
encoding the shortened URL using dual-tone multi-frequency (DTMF) signaling.

16. The computer-readable storage media according to claim 14, further comprising capturing the digital data item while the first client device and the second client device are maintaining the audio telephone call communication session.

17. The computer-readable storage media according to claim 14, further comprising:
prepending a first code to the beginning of the audio signal and/or appending a second code the end of the audio signal; and
transmitting the first code and/or the second code from the first client device to the second client device over the telephone call communication session.

18. The computer-readable storage media according to claim 14, further comprising:
detecting the audio signal embedded in the audio telephone call communication session between the first client device and the second client device;
decoding the audio signal into the URL corresponding to the location of digital data item uploaded to the remote server; and
accessing the digital data item via the URL.

19. The computer-readable storage media according to claim 18, further comprising:
detecting a first code indicating that an audio signal is embedded in the audio telephone call communication session between the first client device and the second client device; and
recording the audio signal until encountering a second code corresponding to the end of the audio signal.

20. (canceled)

21. The system according to claim 1, wherein retrieving the metadata associated with the digital content corresponding to the URL from the one or more servers comprises performing an HTTP (Hypertext Transfer Protocol) GET operation on the URL.
